(19) United States
(12) Patent Application Publication
(10) Pub. No.: US 2025/0261143 A1
(43) Pub. Date: Aug. 14, 2025

(54) INITIAL ACCESS WITH FREQUENCY-TRANSLATING NETWORK CONTROLLED REPEATER

(71) Applicant: QUALCOMM Incorporated, San Diego, CA (US)

(72) Inventors: Sourjya DUTTA, San Diego, CA (US); Navid ABEDINI, Basking Ridge, NJ (US); Kapil GULATI, Belle Mead, NJ (US)

(21) Appl. No.: 18/437,055

(22) Filed: Feb. 8, 2024

(51) Int. Cl. H04W 56/00; H04W 72/1273; H04W 74/0833

(52) U.S. Cl. CPC H04W 56/0015; H04W 72/1273; H04W 74/0833

(57) ABSTRACT

Certain aspects of the present disclosure provide techniques for initial access with frequency-translating network controlled repeaters (FT-NCRs). A method for wireless communication by a user equipment (UE) includes receiving a synchronization signal (SS) burst from a repeater on a first frequency band with a first synchronization raster. The SS burst includes an SS block (SSB) and physical broadcast channel (PBCH) carrying a master information block (MIB) indicating an initial control resource set (CORESET). The method includes determining the SS burst is associated with a serving cell based on the first synchronization raster, wherein the serving cell uses a second synchronization raster associated with a second frequency band.

### FIELD OF THE DISCLOSURE

Aspects of the present disclosure relate to wireless communications, and more particularly, to techniques for initial access procedures in a wireless communication network with frequency-translating network-controlled repeaters (FT-NCRs).

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving a synchronization signal (SS) burst from a repeater on a first frequency band with a first synchronization raster, wherein the SS burst includes an SS block (SSB) and physical broadcast channel (PBCH) carrying a master information block (MIB) indicating an initial control resource set (CORESET); and determining the SS burst is associated with a serving cell based on the first synchronization raster, wherein the serving cell uses a second synchronization raster associated with a second frequency band.

Another aspect provides a method for wireless communication by a network entity. The method includes configuring a repeater associated with the network entity to translate transmissions from the network entity to a first frequency band and to a first synchronization raster and to forward the translated transmissions to a user equipment (UE); and outputting a synchronization signal (SS) burst on a second frequency band using a second synchronization raster, wherein the SS burst includes an SS block (SSB) and physical broadcast channel (PBCH) carrying a master information block (MIB) indicating an initial control resource set (CORESET).

Another aspect provides a method for wireless communication by a repeater. The method includes receiving a synchronization signal (SS) burst from a network entity on a first frequency band with a first synchronization raster, wherein the SS burst includes an SS block (SSB) and physical broadcast channel (PBCH) carrying a master information block (MIB) indicating an initial control resource set (CORESET); and forwarding the SS burst to a user equipment (UE) on a second frequency band with a second synchronization raster.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated BS architecture.

FIG. 3 depicts aspects of an example base station and an example UE.

FIGS. 4A, 4B, 4C, and 4D depict various example aspects of data structures for a wireless communications network.

FIG. 5 depicts an example NCF serving a UE for a BS.

FIG. 6A depicts an example analog FT-NCR.

FIG. 6B depicts an example digital FT-NCR.

FIG. 7 is a call flow diagram illustrating example operations between a UE, a network entity, and an FT-NCR.

FIG. 8A illustrates an example FT-NCR synchronization signal block (SSB) burst location bitmap indicating FT-NCR SSB burst locations from a set of serving cell SSB burst locations.

FIG. 8B illustrates an example FT-NCR SSB burst location bitmap indicating FT-NCR SSB burst locations additional to a set of serving cell SSB burst locations.

FIG. 9 depicts a method for wireless communications at a UE.

FIG. 10 depicts a method for wireless communications at a network entity.

FIG. 11 depicts a method for wireless communications at an FT-NCR.

FIG. 12 depicts aspects of an example communications device.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for initial access with a frequency translating network controlled repeater (FT-NCR).

The FT-NCR has a control link and backhaul link with a network entity (e.g., a base station (BS)) and one or more access links with a user equipment (UE). The network entity receives control information from the network entity over the control link to control the amplify, frequency translation, and forwarding operations of the FT-NCR.

According to certain aspects, the FT-NCR receives synchronization signal (SS) bursts from the network entity over a first frequency band (e.g., via the backhaul link which may use a Uu interface) associated with a first synchronization raster, translates the SS bursts to a second frequency band (e.g., associated with the access link) and to a second synchronization raster associated with the second frequency band, and forwards the translated SS bursts to the UE over the access link on the second frequency band over the second synchronization raster. Based on receiving the SS bursts over the second frequency band and the second synchronization raster, the UE can identify the SS bursts as associated with the same cell (e.g., the serving cell of the network entity).

According to certain aspects, the network entity sends additional SS bursts for the FT-NCR operation. In some cases, the additional SS bursts are transmitted on a non-legacy synchronization raster detectable by the FT-NCR.

According to certain aspects, the network entity provides initial system information to the UE indicating alternate uplink and/or alternate downlink bands, where the alternate bands are associated with the access link for the FT-NCR operations. In some aspects, the additional SS bursts are associated with the alternate bands. In some aspects, the UE uses the alternate uplink bands for sending random access channel requests and/or for sending uplink data to the network entity over the access link. In some aspects, the UE uses the alternate downlink bands to identify downlink signals over the access link as associated with the cell (e.g., the serving cell from the network entity).

According to certain aspects, the initial system information further provides information for the UE to perform random access in response to SS bursts received over the access link.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

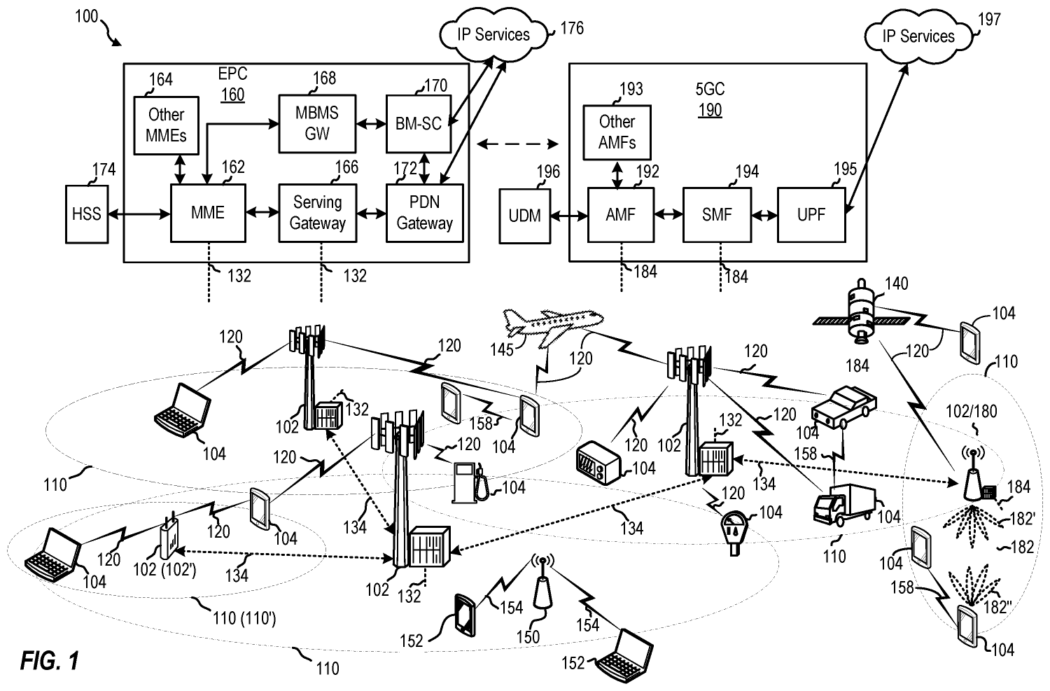

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

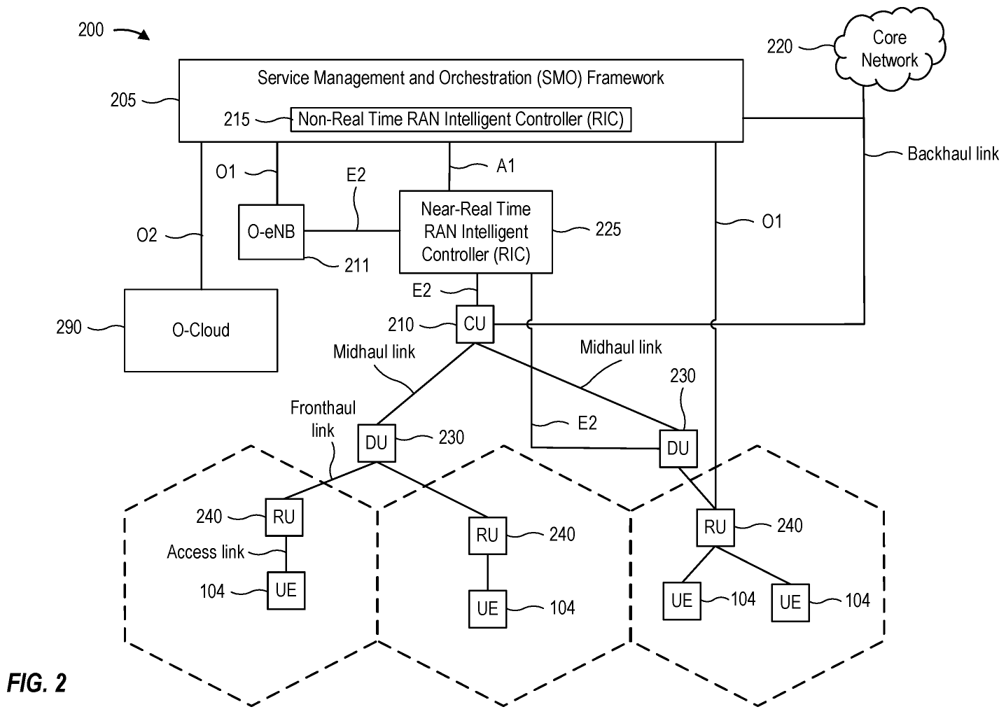

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

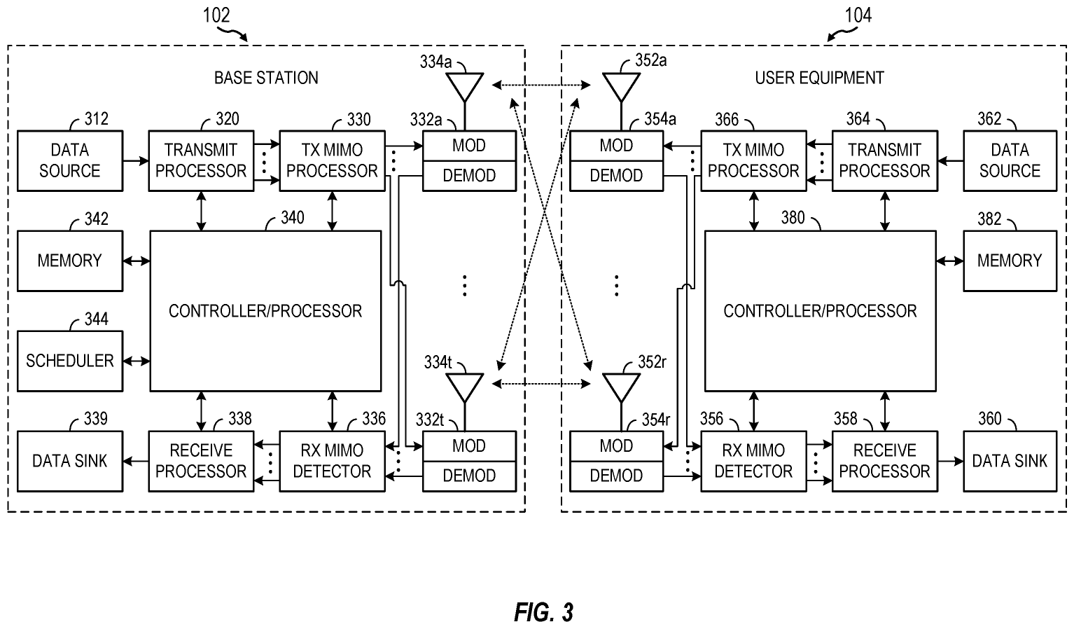

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

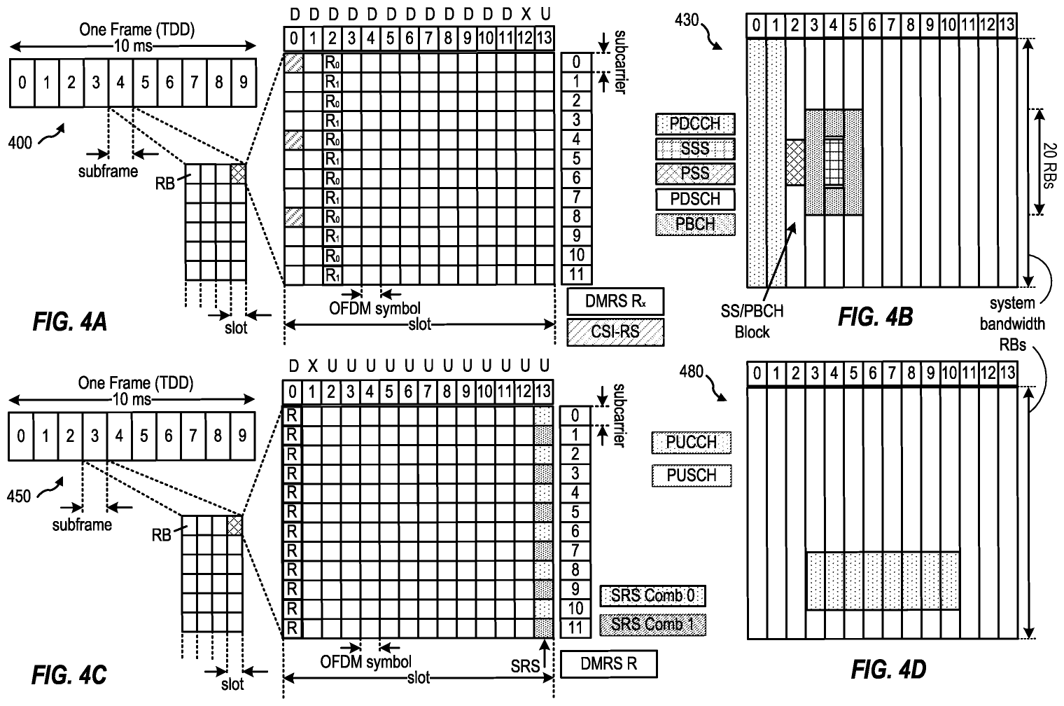

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Synchronization Raster

In some systems, a channel raster defines radio frequency (RF) reference frequencies. The RF reference frequencies are mapped to resource elements (REs) and resource blocks (RBs) to identify channel positions. The system bandwidth may be partitioned into a number of operating bands in which uplink channels, downlink channels, or both uplink and downlink channels can be used for communications between user equipments (UEs) and network entities (e.g., base stations (BSs)). The channels can be configured with different channel bandwidths. Different UE channel bandwidths support different total numbers of RBs (e.g., the maximum transmission bandwidth configuration), NRB. For example, Table 5.3.2-1 of 3GPP TS 38.101-1 v17.7.0 illustrates an example of different NRB dependent on SCS and channel bandwidth in NR.

A global frequency channel raster defines a set of RF reference frequencies, FREF. The RF reference frequency is used in signaling to identify the frequency position of RF channels, SSBs, other elements. In 5G NR, the global frequency raster is defined for all frequencies from 0 GHz to 100 GHz. The granularity of the global frequency raster, AF Global, defines the frequency step size between the RF reference frequencies. The RF reference frequencies are designated by an NR Absolute Radio Frequency Channel Number (NR-ARFCN), N_{REF}. The NR-ARFCN may be in the range (0, 1, . . . , 2016666) on the global frequency raster. The NR-ARFCN can be used to determine an associated RF reference frequency in MHz. For example, F_{REF}=F_{REF-Offs}+ΔF_{Global} (N_{REF}−N_{REF-Offs}), where F_{REF-Offs} and N_{Ref-Offs} are offset values.

The channel raster defines a subset of the RF reference frequencies that can be used to identify the RF channel position in the uplink and downlink. Each subset of RF reference frequencies are associated with different operating bands. The RF reference frequency for an RF channel maps to a resource element on the carrier. For each operating band, a subset of frequencies from the global frequency raster are applicable for that band and forms a channel raster with a granularity ΔF_{Raster}, which may be equal to or larger than ΔF_{Global}. For example, Table 5.4.2.3-1 of 3GPP TS 38.101-1 v17.7.0 illustrates example NR operating bands mapped to RF reference frequency ranges.

The synchronization raster indicates the frequency positions of the SSB that can be used by the UE for system acquisition when explicit signaling of the synchronization block position is not present.

The frequency position of the SS block, SS_{REF}, is defined with a corresponding GSCN. Table 5.4.3.1-1 of 3GPP TS 38.101-1 v17.7.0 illustrates an example of parameters defining the SS_{REF} and GSCN for different frequency ranges. The synchronization raster and the SCS of the SSB may be defined separately for each band. An example of the resource element corresponding to the SS_{REF} is given in clause 5.4.3.2 of 3GPP TS 38.101-1 v17.7.0. An example of a synchronization raster for each band is given in Table 5.4.3.3-1 of 3GPP TS 38.101-1 v17.7.0 with reference to the example SS/PBCH block patterns Cases A-G in Section 4.1 of 3GPP TS 38.213 v17.7.0.

### Aspects Related to Frequency-Translating Network Controlled Repeaters (FT-NCRS)

To improve the coverage and support the increasing number of user equipments (UEs), different methods are considered, among which network densification and millimeter wave (mmW) communications are considered important contributions. Network densification refers to the deployment of multiple access points of different types (e.g., in metropolitan areas). Small nodes, such as relays, integrated access and backhaul (IAB), reconfigurable intelligent surfaces (RIS), and repeaters, may be deployed to assist the communications.

In certain systems, such as 3GPP 5G NR Release 16 and Release 17 systems, IAB nodes are specified as the main relaying nodes. While IAB nodes extend coverage, IAB are, however, relatively complex.

A RIS may be an electromagnetically active artificial structures with low beamforming capabilities, and hence low accuracy, that can be used to reshape the propagation environment such as to improve capacity, coverage and energy efficiency. A RIS may control electromagnetic properties of the RF waves by performing an intelligent adaptation of the phase shift (e.g., adapting a phase matrix) towards the desired direction, without performing any decoding.

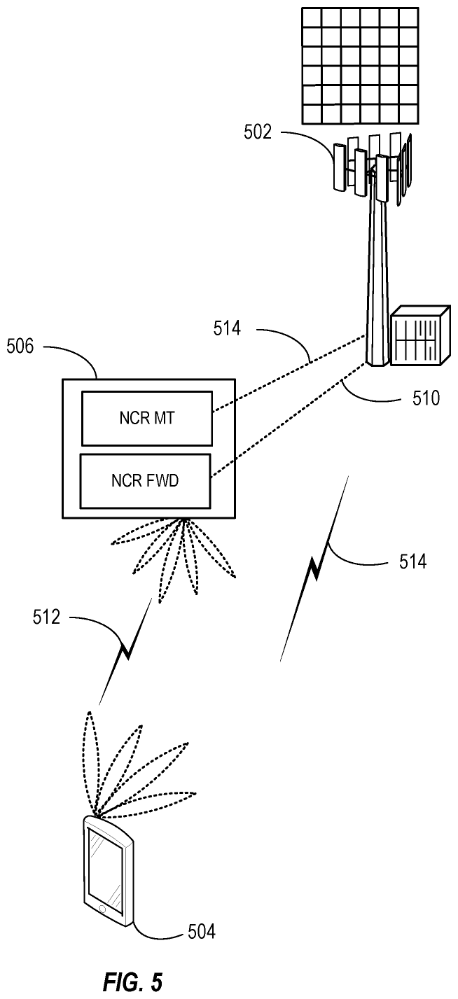

Repeaters (e.g., RF repeaters) enhance coverage, but are low complexity devices, significantly reducing operator costs. FIG. 5 depicts an example repeater 506 serving a user equipment 504 (e.g., such as a UE 104 of FIG. 1) for a base station 502 (e.g., such as a BS 102 of FIG. 1).

The repeater 506 may communicate data with the base station 502 over a backhaul link 510, for example, via the NCR forwarding (FWD) function.

The repeater 506 may receive control information from the base station 502 over a control link 514, for example, via the NCR mobile termination (MT). The control information may control the forwarding operation of the repeater 502. In some aspects, the control link 514 is over a Uu interface.

The repeater 506 may forward data from the base station 502 to a UE 504 and/or from the UE 504 to the base station 502 via access link 512. The NCR FWD of the repeater 506 may perform the amplify-and-forwarding operation of uplink and downlink RF signals between the base station 502 and the UE 504. In some aspects, the repeater 506 can maintain the base station-repeater backhaul link 510 simultaneously with the repeater-user equipment access link 512.

Currently, such repeaters may be fully network-controlled. An NCR may amplify-and-forward signals that the NCR receives without performing any decoding. The NCR may use transmit and receive beamforming to control interference. The NCR can be logically a part of the base station for management purposes.

In some aspects, NCRs are in-band RF repeaters used for extension of network coverage in the FR1 and FR2 bands and may operate transparently to the UE. After power amplification and with beamforming, the NCR forwards a received RF signal in the uplink or downlink. Since the NCR FWD only amplifies and beamforms the RF signal, the NCR may not use any advanced digital receiver or transmitter chains. In some examples, the NCR is transparent to the UE.

In some aspects, an NCR may be a frequency translating NCR (FT-NCR). The FT-NCR, in addition to the amplify and forward operation, translates the signal received on a first frequency band and outputs the signal on a second frequency band. For example, the FT-NCR may output the signal on a band with low load for last-mile connectivity to UEs in the cell edge. In some cases, the FT-NCR may output the signal on another licensed band or on an unlicensed band. Use of an unlicensed band may mitigate interference to other UEs.

In the illustrative example discussed herein, a network entity (e.g., a base station) transmits control information to a FT-NCR on the control link (e.g., over a Uu interface) on a first frequency band f_{c}¹ (e.g., a licensed frequency band). The network entity communicates data with the FT-NCR over the backhaul link on a second frequency band f_{c}². The FT-NCR communicates with a UE over the access link is on a third frequency band f_{c}³ (e.g., a licensed or unlicensed frequency band). In some cases, the first frequency band for the control link is the same frequency band as the second frequency band for the backhaul and a different frequency band than the third frequency band for the access link. In some cases, the network entity also transmits to the UE on a direct link using the first frequency band or the second frequency band.

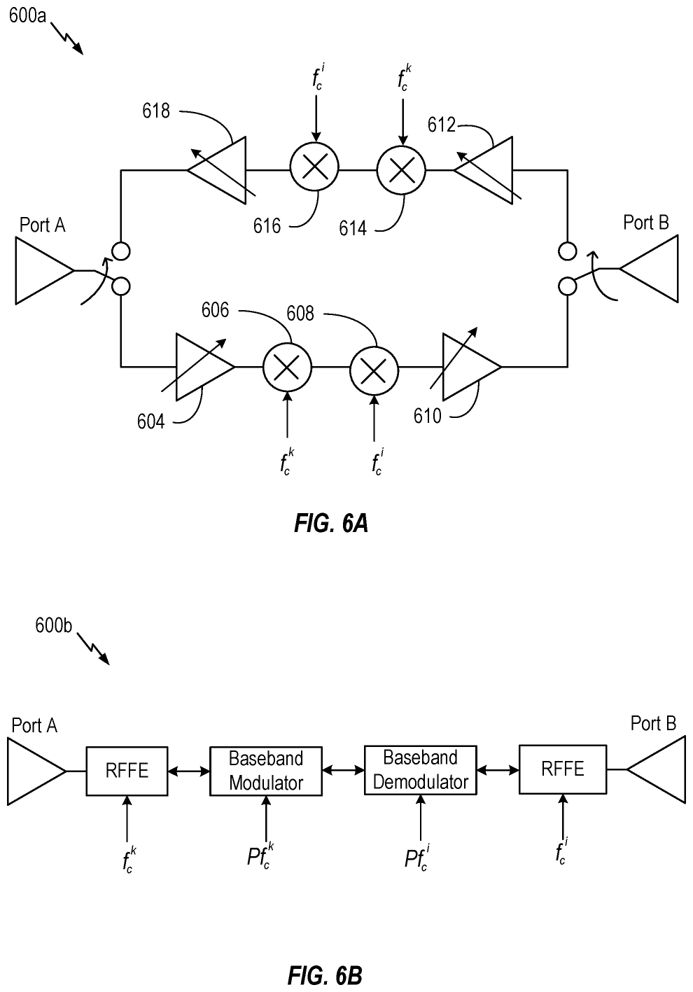

FIG. 6A depicts an example analog FT-NCR 600a. The analog FT-NCR 600a receives a signal over antenna port A. The analog Ft-NCR 600a amplifies the signal, for example, using low noise amplifier (LNA) 604, translates the received signal frequency band f_{c}^{k} to baseband or intermediate frequency (IF) at frequency converter 606, up-converts the signal to output signal frequency band f_{c}ⁱ at frequency converter 608, amplifies the signal using LNA 610, and outputs the signal over the antenna port B. For a signal in the other direction, the analog FT-NCR 600a receives a signal over antenna port B, amplifies the signal, for example, using LNA 612, translates the received signal frequency band f_{c}^{k} to baseband (or IR) at frequency converter 614, up-converts the signal to output signal frequency band f_{c}ⁱ at frequency converter 616, amplifies the signal using LNA 618, and outputs the signal over the antenna port A.

FIG. 6B depicts an example digital FT-NCR 600b. After the digital FT-NCR 600b RF front-end (RFFE) receives the input signal over antenna port A on the received signal frequency band f_{c}^{k}, the digital FT-NCR 600b digitally translates the frequency though the baseband modulator modulating the signal with modulation parameters Pf_{c}^{k} and the baseband demodulator demodulating the signal with demodulation parameters Pf_{c}ⁱ. The RFFE outputs the signal on the output signal frequency band f_{c}ⁱ.

While FT-NCRs allow for coverage extension, because the FT-NCR may be transparent to the UE, the UE needs to be aware that signals being repeated by the FT-NCR are from the same cell as the original signal transmissions from the base station in order to distinguish the signals associated with the cell from signals transmitted by other neighbor cells. For example, the UE may need to identify synchronization signal block (SSB) transmissions received from the FT-NCR as associated with the cell, even though they are received on a different frequency band, in order to perform a random access channel (RACH) procedure with the correct cell. Thus, the UE may need to be configured in initial access or during idle mode paging to distinguish the signals from the same cell and the signals from different cells.

### Aspects Related to Enhanced Initial Access with FT-NCRs

According to certain aspects, a network entity (e.g., a base station) configures a frequency translating network controlled repeater (FT-NCR) to translate synchronization signal (SS) burst transmissions received on a backhaul frequency band, over a first synchronization channel raster associated with the backhaul frequency band, from the network entity to an access link frequency band and to a second synchronization channel raster associated with the access link frequency band.

In some aspects, the FT-NCR translates the SS burst transmissions to a non-legacy synchronization raster. Only non-legacy UEs may decode the SSBs on the non-legacy synchronization raster. The non-legacy synchronization raster may be an additional raster defined for FT-NCR operation.

According to certain aspects, the FT-NCR translates a master information block (MIB), mapping to a control resource set (CORESET), to the access link frequency band and also maps the CORESET transmissions to the access link frequency band. In some aspects, the same resource block (RB) offset and slot offset are indicated in the MIB for both the access link and the backhaul link. That is, the FT-NCR may not change the RB offset and slot offset when performing the frequency translation.

In some aspects, the network entity transmits additional separate SS bursts for the FT-NCR operation. In some aspects, the additional SS bursts are associated with different transmit directions. In some aspects, the additional SS bursts are transmitted by the network entity to the FT-NCR on a non-legacy raster over the backhaul link, the control link, and/or over a Uu interface. In some aspects, the network entity indicates the additional SS burst locations in an initial system information block (SIB). In some aspects, the initial SIB indicates one or more additional uplink frequency bands (or uplink channels) and/or one or more additional downlink frequency bands (or downlink channels) associated with the access link. In some aspects, the additional frequency bands are associated with the additional SS burst locations. In some aspects, a user equipment (UE) that receives one of the additional SS bursts on the Uu interface frequency band (e.g., over the direct link rather than over the access link frequency band) will refrain from decoding the associated CORESET indicated in the MIB and from sending a random access channel (RACH) request in response to the SS burst.

In some aspects, the initial SIB contains information for a UE to perform RACH in response to SS bursts received over the access link frequency band.

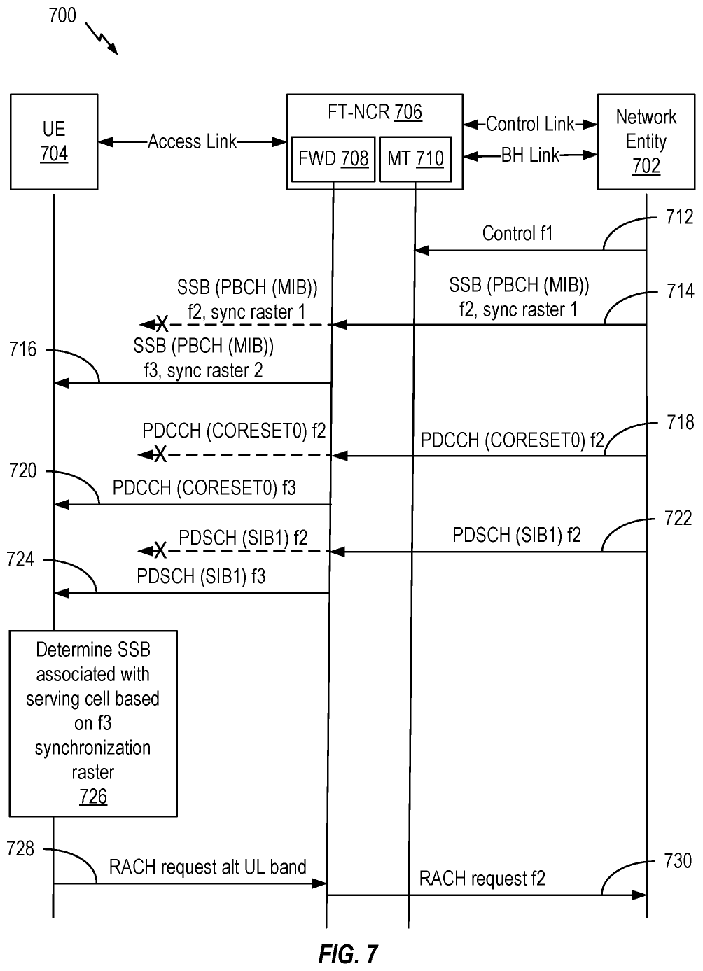

FIG. 7 depicts a process flow 700 for communications in a network between a network entity 702, a UE 704, and a frequency translating network controlled repeater (FT-NCR) 706. In some aspects, the network entity 702 may be an example of the BS 102 depicted and described with respect to FIGS. 1 and 3 or a disaggregated base station depicted and described with respect to FIG. 2. Similarly, the UE 704 may be an example of UE 104 depicted and described with respect to FIGS. 1 and 3. In some aspects, the FT-NCR 706 may be an example of the NCR 506 depicted and described with respect to FIG. 5, the analog NCR 600a depicted and described with respect to FIG. 6A, or the digital NCR 600b depicted and described with respect to FIG. 6B. However, in other aspects, UE 704 may be another type of wireless communications device, network entity 702 may be another type of network entity or network node, and FT-NCR 706 may be another type of repeater, such as those described herein.

As shown in FIG. 7, the FT-NCR 706 may include a mobile termination (MT) 710 and forwarding 708 logical entities. The MT 710 may communicate with the network entity 702 over a control link, which may use a first frequency band f1 (e.g., f_{c}¹). The FWD 708 may communicate with the network entity 702 over a backhaul link, which use a second frequency band (e.g., f_{c}²) via a Uu interface. The network entity 702 may also communicate with the UE 704 via the Uu interface over the second frequency band (e.g., f_{c}²). However, the UE 704 may not be able to receive signals from the network entity 702. For example, UE 704 may be a cell edge UE or due to signal interference or the presence of blockers in the network environment. The FWD 708 may communicate with the 704 over an access link, which may use a third frequency band (e.g., f_{c}³). In some aspects, the second frequency band (e.g., f_{c}²) used for the backhaul link and the third frequency band (e.g., f_{c}³) used for the access link are both in a same frequency range and are both licensed bands.

At 712, the network entity 702 may configure the FT-NCR 706 with control information over the control link. The control information may configure the FT-NCR 706 for the translation, amplify, and forwarding operations.

At 714, the network entity 702 sends a SS burst for the UE 704. The SS burst may be sent via the Uu interface on the second frequency band (e.g., f_{c}²) with the first synchronization raster. As shown, the SS burst may not reach the UE 704, but the SS burst may be received by the FT-NCR 706 over the backhaul link.

In some aspects, SS bursts are transmitted periodically. The transmission pattern may be depend on the subcarrier spacing (SCS) and frequency range. Within a window, a set of SS bursts may be transmitted (e.g., up to 64 SSBs transmitted with beam sweeping). The SS burst may include an SSB and a physical broadcast channel (PBCH) carrying a MIB indicating an initial CORESET (e.g., CORESET0). For example, the MIB may include a parameter pdcch-ConfigSIB1 that determines a common CORESET, a common search space, and some PDCCH parameters. The CORESET may be a set of physical resources (e.g., a specific area on the downlink resource grid), localized to specific search space regions in the frequency domain, and a set of parameters that is used to carry PDCCH.

When the FT-NCR 706 receives the SS burst over the backhaul link on the second frequency band (e.g., f_{c}²) with the first synchronization raster, the FWD 708 amplifies the SS burst transmission and translates the SS burst transmission to the third frequency band (e.g., f_{c}³) and the second synchronization raster for repeating the SS burst to the UE 704 over the access link at 716. In some aspects, the second synchronization raster is a non-legacy synchronization raster.

Once the UE 704 receives the SS burst with the MIB, the UE 704 can determine the initial CORESET and knows where to monitor for a PDCCH.

At 718, the network entity 702 transmits a PDCCH transmission in the CORESET indicated in the MIB. The PDCCH transmission includes downlink control information (DCI) scheduling a physical downlink shared channel (PDSCH) transmission carrying an initial system information block (SIB). The PDCCH transmissions may be sent via the Uu interface on the second frequency band (e.g., f_{c}²) with the first synchronization raster. As shown, the PDCCH transmission may not reach the UE 704, but the PDCCH transmission may be received by the FT-NCR 706 over the backhaul link. The FWD 708 amplifies the PDCCH transmission and translates the PDCCH transmission to the third frequency band (e.g., f_{c}³) and the second synchronization raster for repeating the PDCCH transmission to the UE 704 over the access link at 720.

At 722, the network entity 702 transmits the PDSCH transmission indicated in the DCI. As shown, the PDSCH transmission may not reach the UE 704, but the PDSCH transmission may be received by the FT-NCR 706 over the backhaul link. The FWD 708 amplifies the PDSCH transmission and translates the PDSCH transmission to the third frequency band (e.g., f_{c}³) for repeating the PDSCH transmission to the UE 704 over the access link at 724. The PDSCH transmission may include an initial SIB (e.g., SIB1).

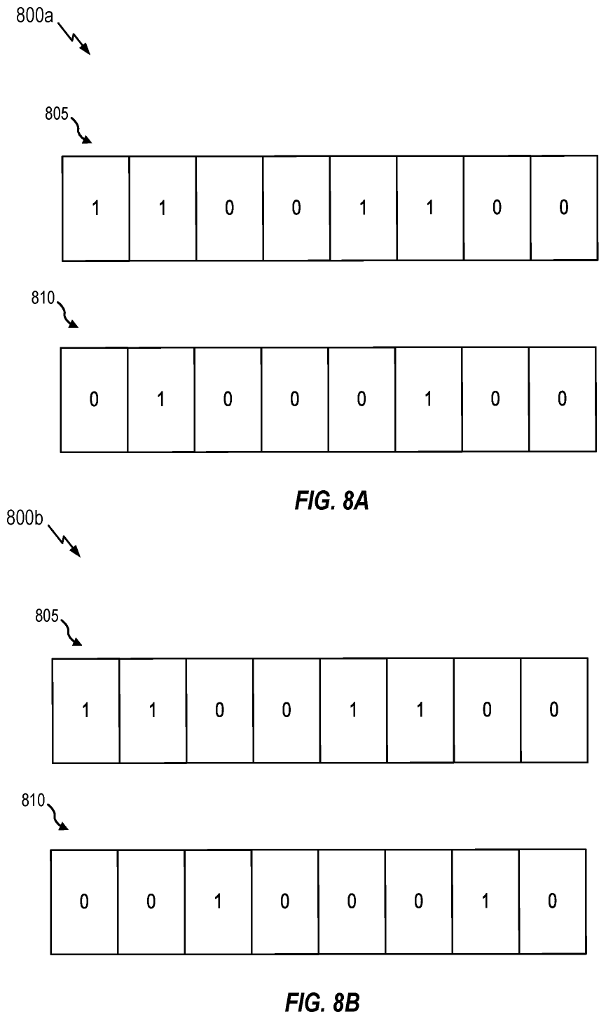

In some aspects, the initial SIB indicates a first set of SS burst locations associated with the serving cell and a second set of SS burst locations associated with the one or more additional frequency bands for downlink. In some aspects, the initial SIB indicates the second set of SS burst locations 810 from the first set of SS burst locations 805 as shown in FIG. 8A. In some aspects, the initial SIB indicates the first set of SS burst locations 805 via a first bitmap and the second set of SS burst locations 810 via a second bitmap, where the second set of SS burst locations are separate from the first set of SS burst locations as shown in FIG. 8B.

The initial SIB may carry information about SSBs. For example, the initial SIB may include a parameter (e.g., ssb-PositionInBurst in ServingCellConfigCommonSIB IE) that configures a time domain transmission pattern of SSBs by the serving cell. In some aspects, the initial SIB further includes a parameter (e.g., downlinkConfigCommonSIB) that configures a list of downlink frequency bands (e.g., frequencyInfoDL IE) and a parameter (e.g., uplinkConfigCommonSIB) that configures a list of uplink frequency bands (e.g., frequencyInfoUL IE). In some aspects, the initial SIB further includes a parameter (e.g., supplementaryUplink IE) that configures one or more supplement uplink SUL) frequency bands.

According to certain aspects, the initial SIB further configures one or more alternate uplink bands and/or one or more alternate downlink bands. For example, the ServingCellConfigCommonSIB may include one or more additional frequencyInfo IEs indicating additional uplink and/or downlink frequency bands that are associated with the access link between the UE and the FT-NCR.

At 726, the UE 704 may determine the SS burst is associated with a serving cell (e.g., network entity 702) based on receiving the SS burst over the third frequency band (e.g., f_{c}³) and the second synchronization raster.

At 728, the UE 704 sends a RACH request, in response to the SS burst, to the serving cell (e.g., network entity 702) based on determining the SS burst, received from the FT-NCR 706, is associated with the same serving cell (e.g., network entity 702). For example, the UE 704 may send the RACH request to the network entity 702 via the FT-NCR 706. The RACH request may be received by the FT-NCR 706 over the access link. The FWD 708 amplifies the RACH request transmission and translates the RACH request transmission to the second frequency band (e.g., f_{c}²) for repeating the RACH request transmission to the network entity 702 over the backhaul link at 730.

In some aspects, the UE 704 is configured (e.g., in the initial SIB) with a first RACH configuration for frequency bands configured for the serving cell and a second RACH configuration for the additional alternate frequency bands associated with the access link. The UE 704 may use one of the alternate frequency bands and the second RACH configuration for sending the RACH request message.

In some aspects, the first RACH configuration may indicate a first reference signal received power (RSRP) detection threshold associated with the first synchronization raster and the second RACH configuration may indicate a second RSRP detection threshold associated with the second synchronization raster. Thus, for SS bursts received over the first synchronization raster, the UE 704 may use the first RSRP detection threshold in determining whether to send a RACH request in response to the SS burst and for SS bursts received over the second synchronization raster, the UE 704 may use the second RSRP detection threshold in determining whether to send a RACH request in response to the SS burst.

In some aspects, the first RACH configuration may indicate a first RACH resources associated with the first synchronization raster and the second RACH configuration may indicate a second RACH resources associated with the second synchronization raster.

In some aspects, the first RACH configuration may indicate a first RACH format (e.g., RACH format A) associated with the first synchronization raster and the second RACH configuration may indicate a second RACH format (e.g., RACH format C) associated with the second synchronization raster. Thus, for SS bursts received over the first synchronization raster, the UE 704 may use the first RACH format to send a RACH request in response to the SS burst and for SS bursts received over the second synchronization raster, the UE 704 may use the second RACH format to send a RACH request in response to the SS burst.

In some aspects, the first RACH configuration may indicate a first RACH preamble maximum transmit power associated with the first synchronization raster and the second RACH configuration may indicate a second RACH preamble maximum transmit power associated with the second synchronization raster. Thus, for SS bursts received over the first synchronization raster, the UE 704 may use the first RACH preamble maximum transmit power to send a RACH request in response to the SS burst and for SS bursts received over the second synchronization raster, the UE 704 may use the second RACH preamble maximum transmit power to send a RACH request in response to the SS burst.

In some aspects, the first RACH configuration may indicate a first RACH response time window associated with the first synchronization raster and the second RACH configuration may indicate a second RACH response time window associated with the second synchronization raster. Thus, for a RACH request sent in response to SS bursts received over the first synchronization raster, the UE 704 may use the first RACH response time window in waiting for a RACH response (RAR) and for a RACH request sent in response to SS bursts received over the second synchronization raster, the UE 704 may use the second RACH response time window in waiting for a RAR.

According to certain aspects, the UE 704 may use the one or more additional uplink bands configured in the initial SIB for sending uplink transmissions for the network entity 702 via the access link.

According to certain aspects, the UE 704 may use the one or more additional downlink bands configured in the initial SIB for receiving downlink transmissions from the network entity 702 via the access link.

In some aspects, the UE 704 will only monitor and/or will send a RACH request only in response to SS bursts sent on the third frequency band associated with the access link. In some aspects, the UE 704 will only monitor and/or will send a RACH request only in response to SS bursts sent on the frequency band associated with the Uu interface. In some aspects, the UE 704 will monitor both and/or will send a RACH request in response to SS bursts sent on either of the access link or the Uu direct link. In some aspects, the UE 704 determines the link to monitor/send RACH based on signal quality criteria, UE capabilities, or other factors.

In some aspects, the UE 704 will send data for the network entity 702 only over the direct link, only over the access link, or over both the direct link or the access link.

According to certain aspects, the initial SIB indicates information for determining whether to use the one or more uplink frequency bands for uplink data transmission or to use the one or more additional uplink frequency bands for uplink data transmission. In some aspects, the information comprises a signal quality measurement threshold (e.g., RSRP and/or receive signal strength indicator (RSSI)). For example, the UE 704 may use the one or more uplink frequency bands for uplink data transmission when the signal quality measurement of the serving cell is at or above the signal quality measurement threshold and the UE 704 may use the one or more additional uplink frequency bands for the uplink data transmission when the signal quality measurement of the serving cell is below the signal quality measurement threshold.

### Example Operations

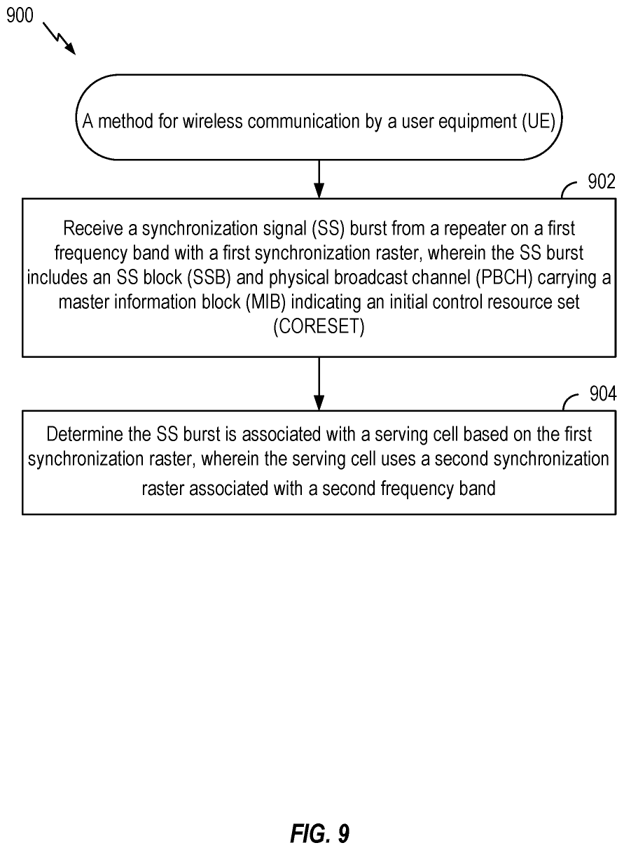

FIG. 9 shows an example of a method 900 of wireless communication by a user equipment (UE), such as a UE 104 of FIGS. 1 and 3.

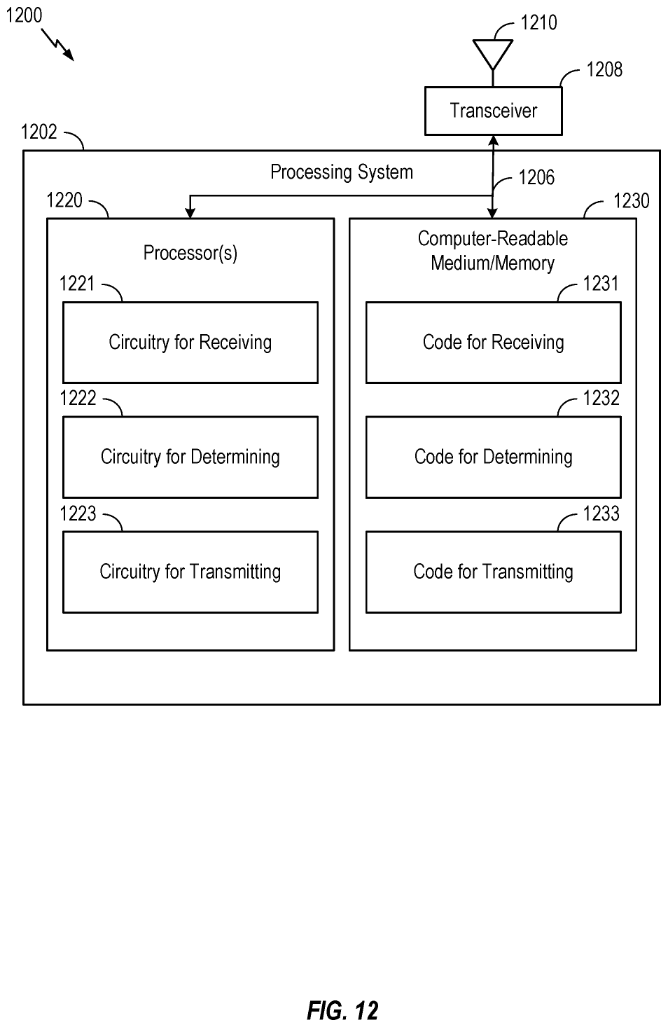

Method 900 begins at step 905 with receiving a synchronization signal (SS) burst from a repeater on a first frequency band with a first synchronization raster, wherein the SS burst includes an SS block (SSB) and physical broadcast channel (PBCH) carrying a master information block (MIB) indicating an initial control resource set (CORESET). In some cases, the operations of this step refer to, or may be performed by, circuitry for receiving and/or code for receiving as described with reference to FIG. 12.

Method 900 then proceeds to step 910 with determining the SS burst is associated with a serving cell based on the first synchronization raster, wherein the serving cell uses a second synchronization raster associated with a second frequency band. In some cases, the operations of this step refer to, or may be performed by, circuitry for determining and/or code for determining as described with reference to FIG. 12.

In some aspects, the first frequency band and the first synchronization raster are associated with an access link between the UE and the repeater.

In some aspects, the first frequency band and the second frequency band are in a same frequency range (FR) in a licensed spectrum.

In some aspects, the method 900 further includes receiving a physical downlink control channel (PDCCH) transmission, in the CORESET indicated in the MIB, from the repeater on the first frequency band with the first synchronization raster, the PDCCH transmission scheduling a physical downlink shared channel (PDSCH) transmission carrying an initial system information block (SIB). In some cases, the operations of this step refer to, or may be performed by, circuitry for receiving and/or code for receiving as described with reference to FIG. 12.

In some aspects, the initial SIB indicates one or more frequency bands for downlink, one or more frequency bands for uplink, and at least one of: one or more additional frequency bands for uplink or one or more additional frequency bands for downlink; and the additional frequency bands are associated with an access link between the UE and the repeater.

In some aspects, the method 900 further includes transmitting one or more uplink transmissions for the serving cell via one of the one or more additional frequency bands for uplink. In some cases, the operations of this step refer to, or may be performed by, circuitry for transmitting and/or code for transmitting as described with reference to FIG. 12.

In some aspects, the method 900 further includes receiving one or more transmissions from the repeater on one of the one or more additional frequency bands for downlink over the first synchronization raster. In some cases, the operations of this step refer to, or may be performed by, circuitry for receiving and/or code for receiving as described with reference to FIG. 12.

In some aspects, the method 900 further includes determining the one or more transmissions are associated with the serving cell. In some cases, the operations of this step refer to, or may be performed by, circuitry for determining and/or code for determining as described with reference to FIG. 12.

In some aspects, the initial SIB indicates a first a random access channel (RACH) configuration associated with the one or more additional frequency bands and with the first synchronization raster and a second RACH configuration associated with the one or more frequency bands and with the second synchronization raster.

In some aspects, the one or more transmissions over the first synchronization raster comprise one or more SSBs, further comprising sending a RACH request message, based on the second RACH configuration, for the serving cell in response to the one or more SSBs received over the first synchronization raster.

In some aspects, the first RACH configuration indicates a first reference signal received power (RSRP) detection threshold associated with the first synchronization raster and the second RACH configuration indicates second RSRP detection threshold associated with the second synchronization raster.

In some aspects, the first RACH configuration indicates first RACH resources associated with the one or more additional frequency bands and the second RACH configuration indicates second RACH resources associated with the one or more frequency bands.

In some aspects, the first RACH configuration indicates a first RACH format associated with the one or more additional frequency bands and the second RACH configuration indicates second RACH format associated with the one or more frequency bands.

In some aspects, the first RACH configuration indicates a first RACH preamble maximum transmit power associated with the one or more additional frequency bands and the second RACH configuration indicates second RACH preamble maximum transmit power associated with the one or more frequency bands.

In some aspects, the first RACH configuration indicates a first RACH response time window associated with the one or more additional frequency bands and the second RACH configuration indicates second RACH response time window associated with the one or more frequency bands.

In some aspects, the initial SIB indicates information for determining whether to use the one or more frequency bands for data transmission or to use the one or more additional frequency bands for data transmission.

In some aspects, the information comprises a signal quality measurement threshold.

In some aspects, the initial SIB indicates a first set of SS burst locations associated with the serving cell and a second set of SS burst locations associated with the one or more additional frequency bands.

In some aspects, the initial SIB indicates the second set of SS burst locations from the first set of SS burst locations.

In some aspects, the initial SIB indicates the first set of SS burst locations via a first bitmap and the second set of SS burst locations via a second bitmap.

In one aspect, method 900, or any aspect related to it, may be performed by an apparatus, such as communications device 1200 of FIG. 12, which includes various components operable, configured, or adapted to perform the method 900. Communications device 1200 is described below in further detail.

Note that FIG. 9 is just one example of a method, and other methods including fewer, additional, or alternative steps are possible consistent with this disclosure.

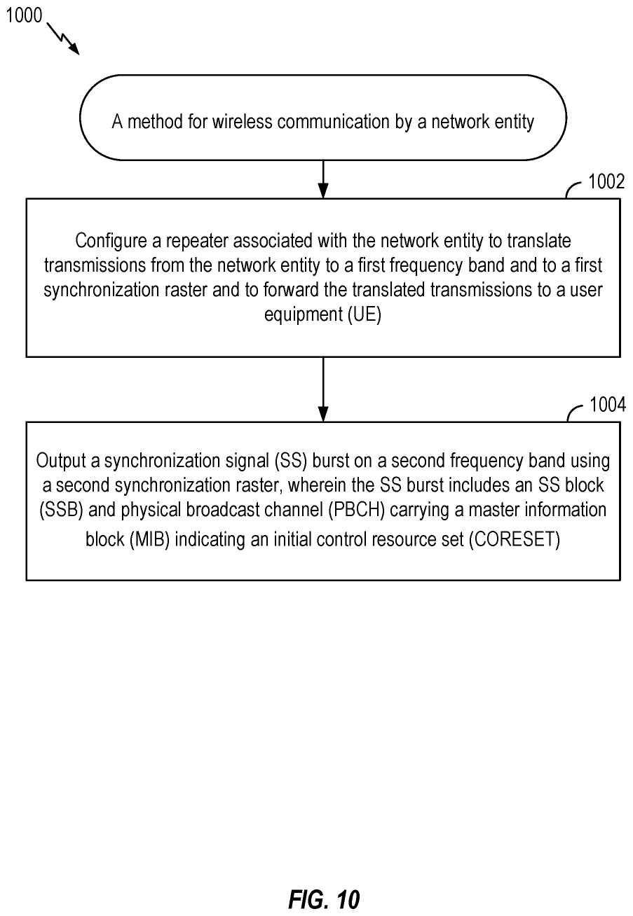

FIG. 10 shows an example of a method 1000 of wireless communication by a network entity, such as a BS 102 of FIGS. 1 and 3, or a disaggregated base station as discussed with respect to FIG. 2.

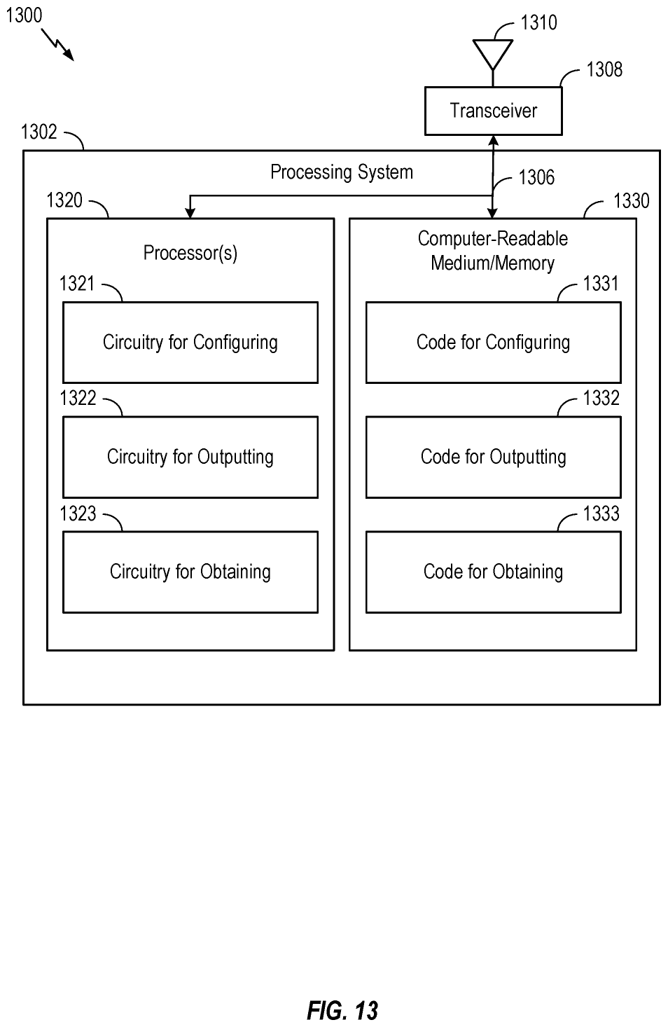

Method 1000 begins at step 1005 with configuring a repeater associated with the network entity to translate transmissions from the network entity to a first frequency band and to a first synchronization raster and to forward the translated transmissions to a user equipment (UE). In some cases, the operations of this step refer to, or may be performed by, circuitry for configuring and/or code for configuring as described with reference to FIG. 13.

Method 1000 then proceeds to step 1010 with outputting a synchronization signal (SS) burst on a second frequency band using a second synchronization raster, wherein the SS burst includes an SS block (SSB) and physical broadcast channel (PBCH) carrying a master information block (MIB) indicating an initial control resource set (CORESET). In some cases, the operations of this step refer to, or may be performed by, circuitry for outputting and/or code for outputting as described with reference to FIG. 13.

In some aspects, the first frequency band and the first synchronization raster are associated with an access link between the UE and the repeater.

In some aspects, the first frequency band and the second frequency band are in a same frequency range (FR) in a licensed spectrum.

In some aspects, the method 1000 further includes outputting a physical downlink control channel (PDCCH) transmission, in the CORESET indicated in the MIB on the second frequency band with the second synchronization raster, the PDCCH transmission scheduling a physical downlink shared channel (PDSCH) transmission carrying an initial system information block (SIB). In some cases, the operations of this step refer to, or may be performed by, circuitry for outputting and/or code for outputting as described with reference to FIG. 13.

In some aspects, the initial SIB indicates one or more frequency bands for downlink, one or more frequency bands for uplink, and at least one of: one or more additional frequency bands for uplink or one or more additional frequency bands for downlink; and the additional frequency bands are associated with an access link between the UE and the repeater.

In some aspects, the method 1000 further includes obtaining one or more uplink transmissions from the UE via the repeater on one of the one or more additional frequency bands for uplink. In some cases, the operations of this step refer to, or may be performed by, circuitry for obtaining and/or code for obtaining as described with reference to FIG. 13.

In some aspects, the method 1000 further includes outputting one or more transmissions on one of the one or more additional frequency bands for downlink. In some cases, the operations of this step refer to, or may be performed by, circuitry for outputting and/or code for outputting as described with reference to FIG. 13.

In some aspects, the initial SIB indicates a first a random access channel (RACH) configuration associated with the one or more additional frequency bands and with the first synchronization raster and a second RACH configuration associated with the one or more frequency bands and with the second synchronization raster.

In some aspects, the method 1000 further includes obtaining a RACH request message from the UE, based on the second RACH configuration, in response to the one or more additional SSBs transmitted over the second synchronization raster. In some cases, the operations of this step refer to, or may be performed by, circuitry for obtaining and/or code for obtaining as described with reference to FIG. 13.

In some aspects, the first RACH configuration indicates a first reference signal received power (RSRP) detection threshold associated with the first synchronization raster and the second RACH configuration indicates second RSRP detection threshold associated with the second synchronization raster.

In some aspects, the first RACH configuration indicates first RACH resources associated with the one or more additional frequency bands and the second RACH configuration indicates second RACH resources associated with the one or more frequency bands.

In some aspects, the first RACH configuration indicates a first RACH format associated with the one or more additional frequency bands and the second RACH configuration indicates second RACH format associated with the one or more frequency bands.

In some aspects, the first RACH configuration indicates a first RACH preamble maximum transmit power associated with the one or more additional frequency bands and the second RACH configuration indicates second RACH preamble maximum transmit power associated with the one or more frequency bands.

In some aspects, the first RACH configuration indicates a first RACH response time window associated with the one or more additional frequency bands and the second RACH configuration indicates second RACH response time window associated with the one or more frequency bands.

In some aspects, the initial SIB indicates information for determining whether to use the one or more frequency bands for data transmission or to use the one or more additional frequency bands for data transmission.

In some aspects, the information comprises a signal quality measurement threshold.

In some aspects, the initial SIB indicates a first set of SS burst locations associated with a serving cell and a second set of SS burst locations associated with the one or more additional frequency bands.

In some aspects, the initial SIB indicates the second set of SS burst locations from the first set of SS burst locations.

In some aspects, the initial SIB indicates the first set of SS burst locations via a first bitmap and the second set of SS burst locations via a second bitmap.

In some aspects, the configuring is via a third frequency band associated with a control link between the network entity and the repeater.

In one aspect, method 1000, or any aspect related to it, may be performed by an apparatus, such as communications device 1300 of FIG. 13, which includes various components operable, configured, or adapted to perform the method 1000. Communications device 1300 is described below in further detail.

Note that FIG. 10 is just one example of a method, and other methods including fewer, additional, or alternative steps are possible consistent with this disclosure.

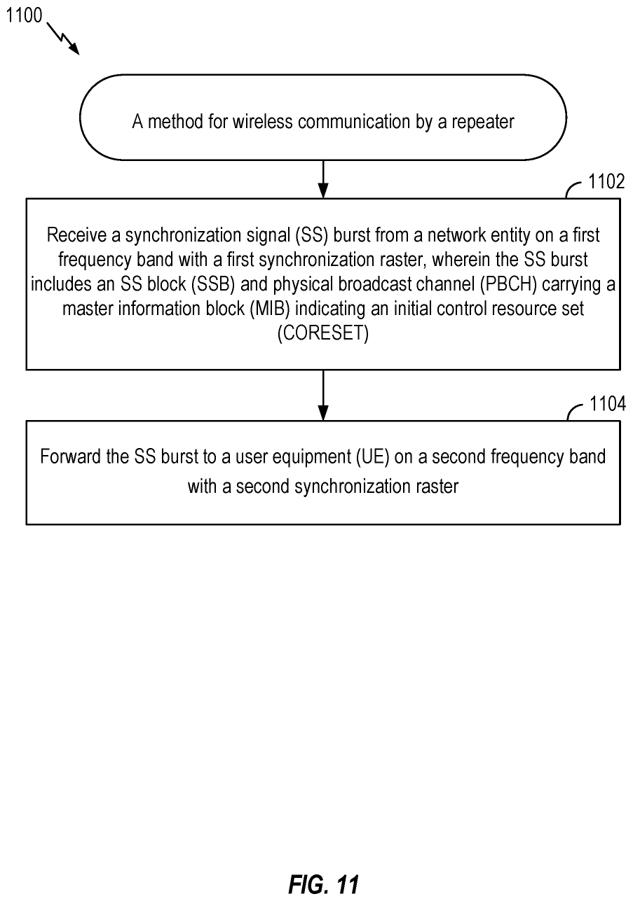

FIG. 11 shows an example of a method 1100 of wireless communication by a repeater. In some examples, the repeater is a user equipment, such as a UE 104 of FIGS. 1 and 3. In some examples, the repeater is a network entity, such as a BS 102 of FIGS. 1 and 3, or a disaggregated base station as discussed with respect to FIG. 2.

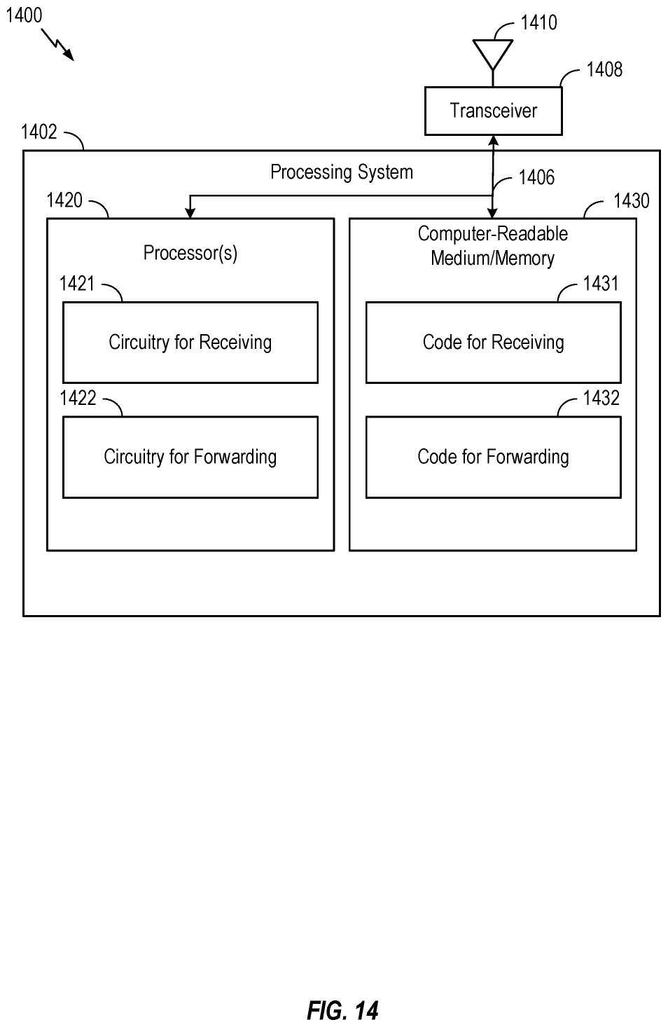

Method 1100 begins at step 1105 with receiving a synchronization signal (SS) burst from a network entity on a first frequency band with a first synchronization raster, wherein the SS burst includes an SS block (SSB) and physical broadcast channel (PBCH) carrying a master information block (MIB) indicating an initial control resource set (CORESET). In some cases, the operations of this step refer to, or may be performed by, circuitry for receiving and/or code for receiving as described with reference to FIG. 14.

Method 1100 then proceeds to step 1110 with forwarding the SS burst to a user equipment (UE) on a second frequency band with a second synchronization raster.

In some cases, the operations of this step refer to, or may be performed by, circuitry for forwarding and/or code for forwarding as described with reference to FIG. 14.

In some aspects, the method 1100 further includes receiving signaling from a network entity configuring the repeater to translate transmissions from the network entity to the second frequency band and to the second synchronization raster and to forward the translated transmissions to the UE. In some cases, the operations of this step refer to, or may be performed by, circuitry for receiving and/or code for receiving as described with reference to FIG. 14.

In some aspects, the configuring is via a third frequency band associated with a control link between the network entity and the repeater.

In some aspects, the second frequency band and the second synchronization raster are associated with an access link between the UE and the repeater.

In some aspects, the first frequency band and the second frequency band are in a same frequency range (FR) in a licensed spectrum.

In some aspects, the method 1100 further includes receiving a physical downlink control channel (PDCCH) transmission, in the CORESET indicated in the MIB, from the network entity on the first frequency band with the first synchronization raster, the PDCCH transmission scheduling a physical downlink shared channel (PDSCH) transmission carrying an initial system information block (SIB). In some cases, the operations of this step refer to, or may be performed by, circuitry for receiving and/or code for receiving as described with reference to FIG. 14.

In some aspects, the method 1100 further includes forwarding the PDCCH transmission to the UE on the second frequency band with the second synchronization raster. In some cases, the operations of this step refer to, or may be performed by, circuitry for forwarding and/or code for forwarding as described with reference to FIG. 14.

In some aspects, the initial SIB indicates one or more frequency bands for downlink, one or more frequency bands for uplink, and at least one of: one or more additional frequency bands for uplink or one or more additional frequency bands for downlink; and the additional frequency bands are associated with an access link between the UE and the repeater.

In some aspects, the method 1100 further includes receiving one or more uplink transmissions for the network entity from the UE via one of the one or more additional frequency bands for uplink. In some cases, the operations of this step refer to, or may be performed by, circuitry for receiving and/or code for receiving as described with reference to FIG. 14.

In some aspects, the method 1100 further includes forwarding the one or more uplink transmissions to the network entity on the first frequency band. In some cases, the operations of this step refer to, or may be performed by, circuitry for forwarding and/or code for forwarding as described with reference to FIG. 14.

In some aspects, the method 1100 further includes receiving one or more transmissions from the network entity on the first frequency band. In some cases, the operations of this step refer to, or may be performed by, circuitry for receiving and/or code for receiving as described with reference to FIG. 14.

In some aspects, the method 1100 further includes forwarding the one or more transmissions to the UE on one of the one or more additional frequency bands for downlink with the first synchronization raster. In some cases, the operations of this step refer to, or may be performed by, circuitry for forwarding and/or code for forwarding as described with reference to FIG. 14.

In some aspects, the initial SIB indicates a first set of SS burst locations associated with the network entity and a second set of SS burst locations associated with the one or more additional frequency bands.

In some aspects, the initial SIB indicates the second set of SS burst locations from the first set of SS burst locations.

In some aspects, the initial SIB indicates the first set of SS burst locations via a first bitmap and the second set of SS burst locations via a second bitmap.

In some aspects, the initial SIB indicates a first a random access channel (RACH) configuration associated with the one or more additional frequency bands and with the first synchronization raster and a second RACH configuration associated with the one or more frequency bands and with the second synchronization raster.

In some aspects, the one or more transmissions over the first synchronization raster comprise one or more SSBs, further comprising: receiving a RACH request message, based on the second RACH configuration, for the network entity in response to the one or more SSBs over the first synchronization raster.

In some aspects, the first RACH configuration indicates a first reference signal received power (RSRP) detection threshold associated with the first synchronization raster and the second RACH configuration indicates second RSRP detection threshold associated with the second synchronization raster.

In some aspects, the first RACH configuration indicates first RACH resources associated with the one or more additional frequency bands and the second RACH configuration indicates second RACH resources associated with the one or more frequency bands.

In some aspects, the first RACH configuration indicates a first RACH format associated with the one or more additional frequency bands and the second RACH configuration indicates second RACH format associated with the one or more frequency bands.

In some aspects, the first RACH configuration indicates a first RACH preamble maximum transmit power associated with the one or more additional frequency bands and the second RACH configuration indicates second RACH preamble maximum transmit power associated with the one or more frequency bands.

In some aspects, the first RACH configuration indicates a first RACH response time window associated with the one or more additional frequency bands and the second RACH configuration indicates second RACH response time window associated with the one or more frequency bands.

In some aspects, the initial SIB indicates information for determining whether to use the one or more frequency bands for data transmission or to use the one or more additional frequency bands for data transmission.

In some aspects, the information comprises a signal quality measurement threshold.

In one aspect, method 1100, or any aspect related to it, may be performed by an apparatus, such as communications device 1400 of FIG. 14, which includes various components operable, configured, or adapted to perform the method 1100. Communications device 1400 is described below in further detail.

Note that FIG. 11 is just one example of a method, and other methods including fewer, additional, or alternative steps are possible consistent with this disclosure.

### Example Communications Devices

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to the transceiver 1255 (e.g., a transmitter and/or a receiver). The transceiver 1255 is configured to transmit and receive signals for the communications device 1200 via the antenna 1260, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code) that when executed by the one or more processors 1210, cause the one or more processors 1210 to perform the method 900 described with respect to FIG. 9, or any aspect related to it. Note that reference to a processor performing a function of communications device 1200 may include one or more processors 1210 performing that function of communications device 1200.

In the depicted example, computer-readable medium/memory 1230 stores code (e.g., executable instructions), such as code for receiving 1235, code for determining 1240, and code for transmitting 1245. Processing of the code for receiving 1235, code for determining 1240, and code for transmitting 1245 may cause the communications device 1200 to perform the method 900 described with respect to FIG. 9, or any aspect related to it.

The one or more processors 1210 include circuitry configured to implement (e.g., execute) the code stored in the computer-readable medium/memory 1230, including circuitry such as circuitry for receiving 1215, circuitry for determining 1220, and circuitry for transmitting 1225. Processing with circuitry for receiving 1215, circuitry for determining 1220, and circuitry for transmitting 1225 may cause the communications device 1200 to perform the method 900 described with respect to FIG. 9, or any aspect related to it.

Various components of the communications device 1200 may provide means for performing the method 900 described with respect to FIG. 9, or any aspect related to it. For example, means for transmitting, sending or outputting for transmission may include transceivers 354 and/or antenna(s) 352 of the UE 104 illustrated in FIG. 3 and/or the transceiver 1255 and the antenna 1260 of the communications device 1200 in FIG. 12. Means for receiving or obtaining may include transceivers 354 and/or antenna(s) 352 of the UE 104 illustrated in FIG. 3 and/or the transceiver 1255 and the antenna 1260 of the communications device 1200 in FIG. 12.

FIG. 13 depicts aspects of an example communications device 1300. In some aspects, communications device 1300 is a network entity, such as BS 102 of FIGS. 1 and 3, or a disaggregated base station as discussed with respect to FIG. 2.

The communications device 1300 includes a processing system 1305 coupled to the transceiver 1355 (e.g., a transmitter and/or a receiver) and/or a network interface 1365. The transceiver 1355 is configured to transmit and receive signals for the communications device 1300 via the antenna 1360, such as the various signals as described herein. The network interface 1365 is configured to obtain and send signals for the communications device 1300 via communication link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1330 via a bus 1350. In certain aspects, the computer-readable medium/memory 1330 is configured to store instructions (e.g., computer-executable code) that when executed by the one or more processors 1310, cause the one or more processors 1310 to perform the method 1000 described with respect to FIG. 10, or any aspect related to it. Note that reference to a processor of communications device 1300 performing a function may include one or more processors 1310 of communications device 1300 performing that function.

In the depicted example, the computer-readable medium/memory 1330 stores code (e.g., executable instructions), such as code for configuring 1335, code for outputting 1340, and code for obtaining 1345. Processing of the code for configuring 1335, code for outputting 1340, and code for obtaining 1345 may cause the communications device 1300 to perform the method 1000 described with respect to FIG. 10, or any aspect related to it.

The one or more processors 1310 include circuitry configured to implement (e.g., execute) the code stored in the computer-readable medium/memory 1330, including circuitry such as circuitry for configuring 1315, circuitry for outputting 1320, and circuitry for obtaining 1325. Processing with circuitry for configuring 1315, circuitry for outputting 1320, and circuitry for obtaining 1325 may cause the communications device 1300 to perform the method 1000 described with respect to FIG. 10, or any aspect related to it.

Various components of the communications device 1300 may provide means for performing the method 1000 described with respect to FIG. 10, or any aspect related to it. Means for transmitting, sending or outputting for transmission may include transceivers 332 and/or antenna(s) 334 of the BS 102 illustrated in FIG. 3 and/or the transceiver 1355 and the antenna 1360 of the communications device 1300 in FIG. 13. Means for receiving or obtaining may include transceivers 332 and/or antenna(s) 334 of the BS 102 illustrated in FIG. 3 and/or the transceiver 1355 and the antenna 1360 of the communications device 1300 in FIG. 13.

FIG. 14 depicts aspects of an example communications device 1400. In some aspects, communications device 1400 is a user equipment, such as UE 104 described above with respect to FIGS. 1 and 3. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1445 (e.g., a transmitter and/or a receiver). In some aspects (e.g., when communications device 1400 is a network entity), processing system 1405 may be coupled to a network interface 1455 that is configured to obtain and send signals for the communications device 1400 via communication link(s), such as a backhaul link, midhaul link, and/or fronthaul link as described herein, such as with respect to FIG. 2. The transceiver 1445 is configured to transmit and receive signals for the communications device 1400 via the antenna 1450, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1425 via a bus 1440. In certain aspects, the computer-readable medium/memory 1425 is configured to store instructions (e.g., computer-executable code) that when executed by the one or more processors 1410, cause the one or more processors 1410 to perform the method 1100 described with respect to FIG. 11, or any aspect related to it. Note that reference to a processor performing a function of communications device 1400 may include one or more processors 1410 performing that function of communications device 1400.

In the depicted example, computer-readable medium/memory 1425 stores code (e.g., executable instructions), such as code for receiving 1430 and code for forwarding 1435. Processing of the code for receiving 1430 and code for forwarding 1435 may cause the communications device 1400 to perform the method 1100 described with respect to FIG. 11, or any aspect related to it.

The one or more processors 1410 include circuitry configured to implement (e.g., execute) the code stored in the computer-readable medium/memory 1425, including circuitry for receiving 1415 and circuitry for forwarding 1420. Processing with circuitry for receiving 1415 and circuitry for forwarding 1420 may cause the communications device 1400 to perform the method 1100 described with respect to FIG. 11, or any aspect related to it.

Various components of the communications device 1400 may provide means for performing the method 1100 described with respect to FIG. 11, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1445 and the antenna 1450 of the communications device 1400 in FIG. 14. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1445 and the antenna 1450 of the communications device 1400 in FIG. 14.

### Example Clauses

Implementation examples are described in the following numbered clauses:
Clause 1: A method for wireless communication by a user equipment (UE), comprising: receiving a synchronization signal (SS) burst from a repeater on a first frequency band with a first synchronization raster, wherein the SS burst includes an SS block (SSB) and physical broadcast channel (PBCH) carrying a master information block (MIB) indicating an initial control resource set (CORESET); and determining the SS burst is associated with a serving cell based on the first synchronization raster, wherein the serving cell uses a second synchronization raster associated with a second frequency band.
Clause 2: The method of Clause 1, wherein the first frequency band and the first synchronization raster are associated with an access link between the UE and the repeater.
Clause 3: The method of any combination of Clauses 1-2, wherein the first frequency band and the second frequency band are in a same frequency range (FR) in a licensed spectrum.
Clause 4: The method of any combination of Clauses 1-3, further comprising receiving a physical downlink control channel (PDCCH) transmission, in the CORESET indicated in the MIB, from the repeater on the first frequency band with the first synchronization raster, the PDCCH transmission scheduling a physical downlink shared channel (PDSCH) transmission carrying an initial system information block (SIB).
Clause 5: The method of Clause 4, wherein: the initial SIB indicates one or more frequency bands for downlink, one or more frequency bands for uplink, and at least one of: one or more additional frequency bands for uplink or one or more additional frequency bands for downlink; and the additional frequency bands are associated with an access link between the UE and the repeater.
Clause 6: The method of Clause 5, further comprising transmitting one or more uplink transmissions for the serving cell via one of the one or more additional frequency bands for uplink.
Clause 7: The method of Clause 5, further comprising: receiving one or more transmissions from the repeater on one of the one or more additional frequency bands for downlink over the first synchronization raster; and determining the one or more transmissions are associated with the serving cell.
Clause 8: The method of any combination of Clauses 5-7, wherein the initial SIB indicates a first a random access channel (RACH) configuration associated with the one or more additional frequency bands and with the first synchronization raster and a second RACH configuration associated with the one or more frequency bands and with the second synchronization raster.
Clause 9: The method of Clause 8, wherein the one or more transmissions over the first synchronization raster comprise one or more SSBs, further comprising sending a RACH request message, based on the second RACH configuration, for the serving cell in response to the one or more SSBs received over the first synchronization raster.
Clause 10: The method of any combination of Clauses 8-9, wherein the first RACH configuration indicates a first reference signal received power (RSRP) detection threshold associated with the first synchronization raster and the second RACH configuration indicates second RSRP detection threshold associated with the second synchronization raster.
Clause 11: The method of any combination of Clauses 5-10, wherein the initial SIB indicates a first set of SS burst locations associated with the serving cell and a second set of SS burst locations associated with the one or more additional frequency bands.
Clause 12: The method of Clause 11, wherein the initial SIB indicates the second set of SS burst locations from the first set of SS burst locations.
Clause 13: The method of Clause 11, wherein the initial SIB indicates the first set of SS burst locations via a first bitmap and the second set of SS burst locations via a second bitmap.
Clause 14: The method of any combination of Clauses 8-13, wherein the first RACH configuration indicates first RACH resources associated with the one or more additional frequency bands and the second RACH configuration indicates second RACH resources associated with the one or more frequency bands.
Clause 15: The method of any combination of Clauses 8-14, wherein the first RACH configuration indicates a first RACH format associated with the one or more additional frequency bands and the second RACH configuration indicates second RACH format associated with the one or more frequency bands.
Clause 16: The method of any combination of Clauses 8-15, wherein the first RACH configuration indicates a first RACH preamble maximum transmit power associated with the one or more additional frequency bands and the second RACH configuration indicates second RACH preamble maximum transmit power associated with the one or more frequency bands.
Clause 17: The method of any combination of Clauses 8-16, wherein the first RACH configuration indicates a first RACH response time window associated with the one or more additional frequency bands and the second RACH configuration indicates second RACH response time window associated with the one or more frequency bands.
Clause 18: The method of any combination of Clauses 8-18, wherein the initial SIB indicates information for determining whether to use the one or more frequency bands for data transmission or to use the one or more additional frequency bands for data transmission.
Clause 19: The method of Clause 18, wherein the information comprises a signal quality measurement threshold.
Clause 20: A method for wireless communication by a network entity, comprising: configuring a repeater associated with the network entity to translate transmissions from the network entity to a first frequency band and to a first synchronization raster and to forward the translated transmissions to a user equipment (UE); and outputting a synchronization signal (SS) burst on a second frequency band using a second synchronization raster, wherein the SS burst includes an SS block (SSB) and physical broadcast channel (PBCH) carrying a master information block (MIB) indicating an initial control resource set (CORESET).
Clause 21: The method of Clause 20, wherein the first frequency band and the first synchronization raster are associated with an access link between the UE and the repeater.
Clause 22: The method of any combination of Clauses 20-21, wherein the first frequency band and the second frequency band are in a same frequency range (FR) in a licensed spectrum.
Clause 23: The method of any combination of Clauses 20-22, further comprising outputting a physical downlink control channel (PDCCH) transmission, in the CORESET indicated in the MIB on the second frequency band with the second synchronization raster, the PDCCH transmission scheduling a physical downlink shared channel (PDSCH) transmission carrying an initial system information block (SIB).
Clause 24: The method of Clause 23, wherein: the initial SIB indicates one or more frequency bands for downlink, one or more frequency bands for uplink, and at least one of: one or more additional frequency bands for uplink or one or more additional frequency bands for downlink; and the additional frequency bands are associated with an access link between the UE and the repeater.
Clause 25: The method of Clause 24, further comprising obtaining one or more uplink transmissions from the UE via the repeater on one of the one or more additional frequency bands for uplink.
Clause 26: The method of any combination of Clauses 24-25, further comprising outputting one or more transmissions on one of the one or more additional frequency bands for downlink.
Clause 27: The method of Clause 24, wherein the initial SIB indicates a first a random access channel (RACH) configuration associated with the one or more additional frequency bands and with the first synchronization raster and a second RACH configuration associated with the one or more frequency bands and with the second synchronization raster.
Clause 28: The method of Clause 27, further comprising obtaining a RACH request message from the UE, based on the second RACH configuration, in response to the one or more additional SSBs transmitted over the second synchronization raster.
Clause 29: The method of any combination of Clauses 27-28, wherein the first RACH configuration indicates a first reference signal received power (RSRP) detection threshold associated with the first synchronization raster and the second RACH configuration indicates second RSRP detection threshold associated with the second synchronization raster.
Clause 30: The method of any combination of Clauses 24-29, wherein the initial SIB indicates a first set of SS burst locations associated with a serving cell and a second set of SS burst locations associated with the one or more additional frequency bands.
Clause 31: The method of Clause 30, wherein the initial SIB indicates the second set of SS burst locations from the first set of SS burst locations.
Clause 32: The method of Clause 30, wherein the initial SIB indicates the first set of SS burst locations via a first bitmap and the second set of SS burst locations via a second bitmap.
Clause 33: The method of any combination of Clauses 27-32, wherein the first RACH configuration indicates first RACH resources associated with the one or more additional frequency bands and the second RACH configuration indicates second RACH resources associated with the one or more frequency bands.
Clause 34: The method of any combination of Clauses 27-33, wherein the first RACH configuration indicates a first RACH format associated with the one or more additional frequency bands and the second RACH configuration indicates second RACH format associated with the one or more frequency bands.
Clause 35: The method of any combination of Clauses 27-34, wherein the first RACH configuration indicates a first RACH preamble maximum transmit power associated with the one or more additional frequency bands and the second RACH configuration indicates second RACH preamble maximum transmit power associated with the one or more frequency bands.
Clause 36: The method of any combination of Clauses 27-35, wherein the first RACH configuration indicates a first RACH response time window associated with the one or more additional frequency bands and the second RACH configuration indicates second RACH response time window associated with the one or more frequency bands.
Clause 37: The method of any combination of Clauses 27-36, wherein the initial SIB indicates information for determining whether to use the one or more frequency bands for data transmission or to use the one or more additional frequency bands for data transmission.
Clause 38: The method of Clause 37, wherein the information comprises a signal quality measurement threshold.
Clause 39: The method of any combination of Clauses 24-38, wherein the configuring is via a third frequency band associated with a control link between the network entity and the repeater.
Clause 40: A method for wireless communication by a repeater, comprising: receiving a synchronization signal (SS) burst from a network entity on a first frequency band with a first synchronization raster, wherein the SS burst includes an SS block (SSB) and physical broadcast channel (PBCH) carrying a master information block (MIB) indicating an initial control resource set (CORESET); and forwarding the SS burst to a user equipment (UE) on a second frequency band with a second synchronization raster.
Clause 41: The method of Clause 40, further comprising receiving signaling from a network entity configuring the repeater to translate transmissions from the network entity to the second frequency band and to the second synchronization raster and to forward the translated transmissions to the UE.
Clause 42: The method of Clause 41, wherein the configuring is via a third frequency band associated with a control link between the network entity and the repeater.
Clause 43: The method of any combination of Clauses 40-42, wherein the second frequency band and the second synchronization raster are associated with an access link between the UE and the repeater.
Clause 44: The method of any combination of Clauses 40-43, wherein the first frequency band and the second frequency band are in a same frequency range (FR) in a licensed spectrum.
Clause 45: The method of any combination of Clauses 40-44, further comprising: receiving a physical downlink control channel (PDCCH) transmission, in the CORESET indicated in the MIB, from the network entity on the first frequency band with the first synchronization raster, the PDCCH transmission scheduling a physical downlink shared channel (PDSCH) transmission carrying an initial system information block (SIB); and forwarding the PDCCH transmission to the UE on the second frequency band with the second synchronization raster.
Clause 46: The method of Clause 45, wherein: the initial SIB indicates one or more frequency bands for downlink, one or more frequency bands for uplink, and at least one of: one or more additional frequency bands for uplink or one or more additional frequency bands for downlink; and the additional frequency bands are associated with an access link between the UE and the repeater.
Clause 47: The method of Clause 46, further comprising: receiving one or more uplink transmissions for the network entity from the UE via one of the one or more additional frequency bands for uplink; and forwarding the one or more uplink transmissions to the network entity on the first frequency band.
Clause 48: The method of any combination of Clauses 46-49, further comprising: receiving one or more transmissions from the network entity on the first frequency band; and forwarding the one or more transmissions to the UE on one of the one or more additional frequency bands for downlink with the first synchronization raster.
Clause 49: The method of any combination of Clauses 45-48, wherein the initial SIB indicates a first a random access channel (RACH) configuration associated with the one or more additional frequency bands and with the first synchronization raster and a second RACH configuration associated with the one or more frequency bands and with the second synchronization raster.
Clause 50: The method of Clause 49, wherein the one or more transmissions over the first synchronization raster comprise one or more SSBs, further comprising: receiving a RACH request message, based on the second RACH configuration, for the network entity in response to the one or more SSBs over the first synchronization raster.
Clause 51: The method of any combination of Clauses 49-50, wherein the first RACH configuration indicates a first reference signal received power (RSRP) detection threshold associated with the first synchronization raster and the second RACH configuration indicates second RSRP detection threshold associated with the second synchronization raster.
Clause 52: The method of any combination of Clauses 49-51, wherein the initial SIB indicates a first set of SS burst locations associated with the network entity and a second set of SS burst locations associated with the one or more additional frequency bands.
Clause 53: The method of Clause 52, wherein the initial SIB indicates the second set of SS burst locations from the first set of SS burst locations.
Clause 54: The method of Clause 52, wherein the initial SIB indicates the first set of SS burst locations via a first bitmap and the second set of SS burst locations via a second bitmap.
Clause 55: The method of Clause 49, wherein the first RACH configuration indicates first RACH resources associated with the one or more additional frequency bands and the second RACH configuration indicates second RACH resources associated with the one or more frequency bands.
Clause 56: The method of any combination of Clauses 49-55, wherein the first RACH configuration indicates a first RACH format associated with the one or more additional frequency bands and the second RACH configuration indicates second RACH format associated with the one or more frequency bands.
Clause 57: The method of any combination of Clauses 49-56, wherein the first RACH configuration indicates a first RACH preamble maximum transmit power associated with the one or more additional frequency bands and the second RACH configuration indicates second RACH preamble maximum transmit power associated with the one or more frequency bands.
Clause 58: The method of any combination of Clauses 49-57, wherein the first RACH configuration indicates a first RACH response time window associated with the one or more additional frequency bands and the second RACH configuration indicates second RACH response time window associated with the one or more frequency bands.
Clause 59: The method of any combination of Clauses 49-58, wherein the initial SIB indicates information for determining whether to use the one or more frequency bands for data transmission or to use the one or more additional frequency bands for data transmission.
Clause 60: The method of Clause 59, wherein the information comprises a signal quality measurement threshold.
Clause 61: An apparatus, comprising: at least one memory comprising executable instructions; and at least one processor configured to execute the executable instructions and cause the apparatus to perform a method in accordance with any one of Clauses 1-60.
Clause 62: An apparatus, comprising means for performing a method in accordance with any one of Clauses 1-60.
Clause 63: A non-transitory computer-readable medium comprising executable instructions that, when executed by at least one processor of an apparatus, cause the apparatus to perform a method in accordance with any one of Clauses 1-60.
Clause 64: A computer program product embodied on a computer-readable storage medium comprising code for performing a method in accordance with any one of Clauses 1-60.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

### REPMF

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE) comprising:
memory storing computer executable code; and
at least one processor coupled with the memory configured to the execute computer executable code and cause the UE to:
receiving a synchronization signal (SS) burst from a repeater on a first frequency band with a first synchronization raster, wherein the SS burst includes an SS block (SSB) and physical broadcast channel (PBCH) carrying a master information block (MIB) indicating an initial control resource set (CORESET); and
determining the SS burst is associated with a serving cell based on the first synchronization raster, wherein the serving cell uses a second synchronization raster associated with a second frequency band.

2. The UE of claim 1, wherein the first frequency band and the first synchronization raster are associated with an access link between the UE and the repeater.

3. The UE of claim 1, wherein the first frequency band and the second frequency band are in a same frequency range (FR) in a licensed spectrum.

4. The UE of claim 1, wherein the at least one processor is further configured to cause the UE to receive a physical downlink control channel (PDCCH) transmission, in the CORESET indicated in the MIB, from the repeater on the first frequency band with the first synchronization raster, the PDCCH transmission scheduling a physical downlink shared channel (PDSCH) transmission carrying an initial system information block (SIB).

5. The UE of claim 4, wherein:
the initial SIB indicates one or more frequency bands for downlink, one or more frequency bands for uplink, and at least one of: one or more additional frequency bands for uplink or one or more additional frequency bands for downlink; and
the additional frequency bands are associated with an access link between the UE and the repeater.

6. The UE of claim 5, wherein the at least one processor is further configured to cause the UE to transmit one or more uplink transmissions for the serving cell via one of the one or more additional frequency bands for uplink.

7. The UE of claim 5, wherein the at least one processor is further configured to cause the UE to:
receive one or more transmissions from the repeater on one of the one or more additional frequency bands for downlink over the first synchronization raster; and
determine the one or more transmissions are associated with the serving cell.

8. The UE of claim 7, wherein the initial SIB indicates a first a random access channel (RACH) configuration associated with the one or more additional frequency bands and with the first synchronization raster and a second RACH configuration associated with the one or more frequency bands and with the second synchronization raster.

9. The UE of claim 8, wherein the one or more transmissions over the first synchronization raster comprise one or more SSBs, further comprising sending a RACH request message, based on the second RACH configuration, for the serving cell in response to the one or more SSBs received over the first synchronization raster.

10. The UE of claim 8, wherein the first RACH configuration indicates a first reference signal received power (RSRP) detection threshold associated with the first synchronization raster and the second RACH configuration indicates second RSRP detection threshold associated with the second synchronization raster.

11. The UE of claim 5, wherein the initial SIB indicates a first set of SS burst locations associated with the serving cell and a second set of SS burst locations associated with the one or more additional frequency bands.

12. The UE of claim 11, wherein the initial SIB indicates the second set of SS burst locations from the first set of SS burst locations.

13. The UE of claim 11, wherein the initial SIB indicates the first set of SS burst locations via a first bitmap and the second set of SS burst locations via a second bitmap.

14. The UE of claim 8, wherein the first RACH configuration indicates first RACH resources associated with the one or more additional frequency bands and the second RACH configuration indicates second RACH resources associated with the one or more frequency bands.

15. The UE of claim 8, wherein the first RACH configuration indicates a first RACH format associated with the one or more additional frequency bands and the second RACH configuration indicates second RACH format associated with the one or more frequency bands.

16. The UE of claim 8, wherein the first RACH configuration indicates a first RACH preamble maximum transmit power associated with the one or more additional frequency bands and the second RACH configuration indicates second RACH preamble maximum transmit power associated with the one or more frequency bands.

17. The UE of claim 8, wherein the first RACH configuration indicates a first RACH response time window associated with the one or more additional frequency bands and the second RACH configuration indicates second RACH response time window associated with the one or more frequency bands.

18. The UE of claim 8, wherein the initial SIB indicates information for determining whether to use the one or more frequency bands for data transmission or to use the one or more additional frequency bands for data transmission.

19. A network entity comprising:
memory storing computer executable code; and
at least one processor coupled with the memory configured to the execute computer executable code and cause the network entity to:
configure a repeater associated with the network entity to translate downlink transmissions from the first network entity to a first frequency band and to a first synchronization raster; and
output a synchronization signal (SS) burst on a second frequency band using a second synchronization raster, wherein the SS burst includes an SS block (SSB) and physical broadcast channel (PBCH) carrying a master information block (MIB) indicating an initial control resource set (CORESET).

20. A repeater comprising:
memory storing computer executable code; and
at least one processor coupled with the memory configured to the execute computer executable code and cause the repeater to:
receive a synchronization signal (SS) burst from a network entity on a first frequency band with a first synchronization raster, wherein the SS burst includes an SS block (SSB) and physical broadcast channel (PBCH) carrying a master information block (MIB) indicating an initial control resource set (CORESET); and
forward the SS burst to a user equipment (UE) on a second frequency band with a second synchronization raster.
